(19) United States
(12) Patent Application Publication
(10) Pub. No.: US 2014/0046016 A1
(43) Pub. Date: Feb. 13, 2014

(54) RESIN COMPOSITION FOR OPTICAL FILM AND OPTICAL FILM USING THE SAME

(71) Applicants: Byoung-II Kang, Daejeon-si (KR); Chang-Hun Han, Daejeon-si (KR); Dae-Woo Lee, Busan (KR); Jae-Bum Seo, Daejeon-si (KR); Beom-Seok Kim, Daejeon-si (KR); Eun-Jung Choi, Daejeon-si (KR); Joon-Sik Kim, Yeosu-si (KR); Nam-Jeong Lee, Daejeon-si (KR); Su-Kyung Kim, Daejeon-si (KR); Da-Eun Sung, Daejeon-si (KR)

(72) Inventors: Byoung-II Kang, Daejeon-si (KR); Chang-Hun Han, Daejeon-si (KR); Dae-Woo Lee, Busan (KR); Jae-Bum Seo, Daejeon-si (KR); Beom-Seok Kim, Daejeon-si (KR); Eun-Jung Choi, Daejeon-si (KR); Joon-Sik Kim, Yeosu-si (KR); Nam-Jeong Lee, Daejeon-si (KR); Su-Kyung Kim, Daejeon-si (KR); Da-Eun Sung, Daejeon-si (KR)

(73) Assignee: LG CHEM, LTD., Seoul (KR)

(21) Appl. No.: 14/009,488

(22) PCT Filed: Jun. 1, 2012
(86) PCT No.: PCT/KR2012/004370

§ 371 Date: Oct. 2, 2013

(30) Foreign Application Priority Data
Jun. 1, 2011 (KR) 10-2011-0052907
May 16, 2012 (KR) 10-2012-0051944

(51) Int. Cl. C08G 67/04; C08F 20/10

(52) U.S. Cl. CPC C08G 67/04; C08F 20/10
USPC 526/318.44; 528/354

(57) ABSTRACT

The present invention relates to a resin composition for an optical film comprising a copolymer which includes an alkyl (meth)acrylate unit, a (meth)acrylate unit having a benzene ring, and a (meth)acrylic acid unit, wherein a content of a residual monomer is less than 2000 ppm in the resin composition and an optical film using the same.

### TECHNICAL FIELD

The present invention relates to a resin composition for an optical film and an optical film using the same, and more particularly, to a resin composition for an optical film having good optical characteristics, heat resistance, and low dimensional change with temperature variations, and an optical film using the resin composition.

### BACKGROUND ART

Recently, with the development of optical technologies, various kinds of display technologies such as plasma display panels (PDPs), liquid crystal displays (LCDs), and organic electroluminescence displays (OLEDs) capable of replacing related art cathode-ray tubes (CRTs) have been suggested and came into the market. In addition, various polymer films such as a polarizing film, a polarizer protection film, a retardation film, a light guide plate, and a plastic substrate are used for these display devices, and polymer materials having improved properties are increasingly demanded.

Triacetil cellulose (TAC) films used as a polarizer protection film are most commonly used for polymer films for displays. However, TAC films have problems such as deterioration of polarization degree, separation of a protection film from a polarizer, or deterioration of optical characteristics when the TAC films are used under conditions of high temperature or high humidity. In order to solve these problems, as an alternative to the TAC film, polymer films including polystyrene, acryl such as methyl methacrylate or polycarbonate series having excellent heat resistance, have been proposed. These polymer films have excellent heat resistance; however, birefringence occurs during formation of films. Thus, optical characteristics of display devices may be deteriorated by the birefringence of the films when these films are applied to the display device.

To solve this problem caused by the birefringence, a method of copolymerizing or blending a monomer or polymer having positive birefringence and a monomer or polymer having negative birefringence has been suggested in order to obtain a material for a polymer film having a low retardation value as well as good heat resistance. Among these methods, a representative one is a method of preparing a copolymer consisting of benzyl methacrylate and methyl methacrylate. The optical characteristics of benzyl methacrylate and methyl methacrylate are excellent due to having a retardation value close to 0; however, a curling phenomenon in which a polarizing film is severely bent or distorted occurs after being laminated on the polarizing film due to a great dimensional change with a temperature variation, i.e., a high coefficient of thermal expansion. Such a curling phenomenon causes light leakage in the polarizing film to result in a deterioration of display quality, and to lead liquid crystals to be damaged in a display panel. Therefore, this is the urgent issue to be solved out.

### DETAILED DESCRIPTION OF INVENTION

### Technical Problem

In order to solve the problems encountered in the related art as mentioned above, the present invention provides a resin composition for an optical film having low dimensional change with temperature variations as well as excellent optical characteristics and heat resistance, and also provides an optical film using the resin composition.

### Technical Solution

According to an aspect of the present invention, there is provided a resin composition for an optical film comprising a copolymer which includes, as essential elements, an alkyl (meth)acrylate unit, a (meth)acrylate unit having a benzene ring, and a (meth)acrylic acid unit, and optionally, further includes a unit represented by the following Chemical Formula I, wherein a content of residual monomer in the resin composition is 2000 ppm or less,

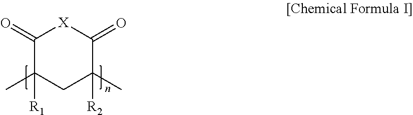

where X is nitrogen (N) or oxygen (O), and
R₁ and R₂ are hydrogen (H), a C₁ to C₁₀ alkyl group, a C₃ to C₂₀ cycloalkyl group, or a C₃ to C₂₀ aryl group, respectively.

According to another aspect of the present invention, there is provided an optical film prepared by using the resin composition for optical film, and a polarizing plate including the optical film as a protective film.

### Effects of Invention

According to the present invention, an optical film using a resin composition for an optical film can be used as a protective film for a polarizing plate since the optical film has a low coefficient of thermal expansion as well as excellent optical characteristics and heat resistance.

### Best Mode for Invention

Hereinafter, the present invention will be described in detail.

The present inventors have assiduously and repetitively conduct researches in order to develop materials for an optical film having a low coefficient of thermal expansion as well as excellent optical characteristics and heat resistance, and resultantly found that when a content of a residual monomer in a resin composition obtained by copolymerizing alkyl (meth)acrylate, a (meth)acrylate having a benzene ring, and (meth)acrylic acid monomers, is controlled to a specific content level, an optical film having a retardation value close to 0, excellent heat resistance and a low coefficient of thermal expansion can be formed.

The resin composition for an optical film of the present invention comprises a copolymer which includes, as essential elements, an alkyl (meth)acrylate unit, a (meth)acrylate unit having a benzene ring, and a (meth)acrylic acid unit, and optionally includes a unit represented by following Chemical Formula 1.

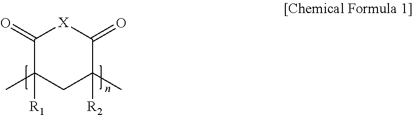

where X is N or O, and
R₁ and R₂ are H, a C₁ to C₁₀ alkyl group, and a C₃ to C₂₀ cycloalkyl group or a C₃ to C₂₀ aryl group respectively.

In the resin composition according to the present invention, the alkyl (meth)acrylate refers to both alkyl acrylate and alkyl methacrylate, but the resin composition is not particularly limited thereto. The alkyl (meth)acrylate contains an alkyl group preferably having 1 to 10 carbon atoms, more preferably 1 to 5 carbon atoms, and most preferably a methyl or ethyl group, in terms of optical transparency, compatibility, processability and productivity, and it is most preferable that the alkyl (meth)acrylate contains a methyl group or ethyl group.

Meanwhile, the (meth)acrylate having a benzene ring allows the optical film according to the present invention to have an appropriate retardation value and also have compatibility between alkyl (meth)acrylate and (meth)acrylic acid. For example, the (meth)acrylate may be one or more species selected from the group consisting of benzyl methacrylate, benzyl acrylate, 1-phenylethyl methacrylate, 2-phenoxyethyl methacrylate, 2-phenylethyl methacrylate, 3-phenylpropyl methacrylate, 3-phenylpropyl acrylate and 2-phenoxyethyl acrylate, but is not particularly limited thereto. Most of all, benzyl methacrylate and benzyl acrylate are particularly preferable, and methacrylic acid is most preferable.

In addition, the (meth)acrylic acid functions to improve heat resistance and lower a coefficient of thermal expansion by introducing a polar functional group, and may be, for example, acrylic acid, methacrylic acid, methylacrylic acid, methylmethacrylic acid, ethylacrylic acid, ethylmethacrylic acid, butylacrylic acid or butylmethacrylic acid. In particular, methacrylic acid is preferable.

The unit represented by Chemical Formula 1 functions to improve characteristics such as retardation value and coefficient of thermal expansion, and may be glutaric anhydride, glutaric acid imide, etc. Most of all, glutaric anhydride is particularly preferable. In general, when a bulky functional group which can restrain a chain conformation of a polymer chain is introduced to a polymer main chain, the coefficient of thermal expansion may be decreased. However, for example, when polymers including a bulky functional group such as styrene or polycarbonate are used, the coefficient of thermal expansion may be decreased but birefringence may occur by stretching, thus leading to deterioration in optical characteristics. From the results of the present inventors, it was found out that a copolymer including the unit represented by Chemical Formula 1 may efficiently reduce a coefficient of thermal expansion without affection on optical characteristics.

Meanwhile, when the resin composition according to the present invention is a terpolymer including an alkyl (meth)acrylate unit, a (meth)acrylate unit having a benzene ring, and a (meth)acrylic acid, a content ratio among the alkyl (meth)acrylate unit, the (meth)acrylate unit having the benzene ring and the (meth)acrylic acid unit in the terpolymer is preferably 70-95:2-10:3-20 by weight. This is because it is possible to obtain a preferable retardation value, a glass transition temperature and a coefficient of thermal expansion when the content ratio among the respective components falls within this range.

When the resin composition according to the present invention is a quaternary copolymer resin including an alkyl (meth)acrylate unit, a (meth)acrylate unit having a benzene ring, a (meth)acrylic acid unit, and a unit represented by Chemical Formula 1, a content ratio among the alkyl (meth)acrylate unit, the (meth)acrylate unit having the benzene ring, the (meth)acrylate unit, and the unit represented by Chemical Formula 1 in the quaternary polymer is preferably 60-90:2-10:3-10:5-20 by weight. This is because it is possible to obtain a preferable retardation value, a glass transition temperature and a coefficient of thermal expansion when the content ratio among the respective components falls within this range.

Also, in the resin composition according to the present invention, a content of unreacted residual monomer is 2000 ppm or less, preferably 1500 ppm or less, most preferably 1000 ppm or less. The present inventors have conducted researches and resultantly found that, when the content of the unreacted residual monomer in the composition exceeds 2000 ppm, a glass transition temperature of the resin composition may be decreased to deteriorate heat resistance, and contamination by the adsorption of residual monomer on a film and/or the development of air bubbles during film preparation may occur, thereby leading to deterioration in optical characteristics. More specifically, in a film manufactured through a melt extrusion process, a vacuum vent part of an extruder may be easily clogged if a content of a residual monomer is high. Generally, since residual monomers may exist in the form of monomer or oligomer, they have low thermal stability to cause air bubbles to be generated during film formation, thereby making it difficult to manufacture products. The generation of air bubbles tends to be slightly decreased as the film forming temperature is decreased. However, when the film is formed at low temperature, discharging may not be sufficiently carried out due to high pressure inside the extruder, productivity may also be dramatically lowered, and stains may remain on the exterior of the film because the residual monomer may not be sufficiently eliminated.

Therefore, to obtain excellent optical characteristics, i.e. obtain a retardation value close to 0, good heat resistance, a low coefficient of thermal expansion, a content of a residual monomer should be maintained to a specific content level or less. Especially, when the content of residual monomer is 1000 ppm or less, an amount of air bubbles generated may be remarkably reduced during film formation.

The resin composition of the present invention having the low content of residual monomers may be prepared by mixing and polymerizing monomers of respective components and drying the resulting mixture in a specific temperature range for a predetermined time. More specifically, the method of preparing the resin composition according to the present invention, includes: (1) copolymerizing an alkyl (meth)acrylate monomer, a (meth)acrylate monomer having a benzene ring, and a (meth)acrylic acid monomer; and (2) drying the resulting copolymerized product at 240° C. to 270° C. for 30 minutes to 2 hours. The copolymerizing operation may be carried out by using a well-known copolymerization process such as solution polymerization, bulk polymerization, suspension polymerization and emulsion polymerization, and preferably the copolymerizing operation is performed using bulk polymerization. After completion of copolymerization, the drying operation is carried out for controlling the content of a residual monomer in a resin product. The drying temperature is preferably between about 240° C. to about 270° C., and the drying time is preferably about 0.5 to about 2 hours. When the drying temperature is less than 240° C., evaporation of the residual monomer may not be sufficient so that it is difficult to control the content of residual monomer. On the contrary, when the drying temperature is more than 270° C., the resin composition may be thermally deformed due to high temperature. Also, when the drying time is less than 0.5 hour, evaporation of the residual monomer may not be sufficient so that it is difficult to control the content of residual monomer. In contrast, when a drying time is more than 2 hours, productivity is significantly decreased due to thermal deformation and thermal decomposition of the resin.

Meanwhile, when a discharging amount is preferably about 3 kg/hr to about 6 kg/hr based on 20-L pilot reactor in the drying operation. If the discharging amount is less than 3 kg/hr, transparency becomes poor due to deterioration of the resin; and if the discharging amount is more than 6 kg/hr, drying may not be sufficiently performed to cause a lot of residues to be left remaining.

The resin composition of the present invention prepared by the above-described method has a glass transition temperature of about 120° C. to about 500° C., preferably 125° C. to 500° C., more preferably 125° C. to 200° C., and most preferably 130° C. to 200° C. Also, the resin composition according to the present invention may have a weight average molecular weight of 50,000 to 500,000, and more preferably about 100,000 to about 500,000, when considering processability, heat resistance and productivity.

In addition, the resin composition according to the present invention has excellent optical characteristics such as a haze value of about 0.1 to about 3%, light transmittance of 90% or more, and yellow index of 4 or less for a 3-mm thick injection specimen.

Another aspect of the present invention relates to an optical film containing the resin composition according to the present invention.

The optical film may be prepared in the form of a film by processing the resin composition using well-known methods in the related art, such as solution casting or extrusion. When considering economic feasibility, the extrusion is more preferable. In some cases, during film formation, additives like a reformer may also be added in such an amount not deteriorating film properties, and the method may further include uniaxially or biaxially stretching the film.

When the film is stretched uniaxially or biaxially, the stretching process may be performed in either or both of the machine direction (MD) and the transverse direction (TD). When the stretching is performed in both the machine direction (MD) and transverse direction (TD), the stretching may be performed in one of the directions first and then performed in the other direction, or the stretching may be simultaneously performed in both of the directions. The stretching may be performed through a single stage or in multiple stages. When the stretching is performed in the machine direction (MD), the stretching may be performed by using a difference in speed between rolls. When the stretching is performed in the transverse direction (TD), a tenter may be used. A rail initiating angle of the tenter is set to 10° or less, thus suppressing a Bowing phenomenon that occurs during the transverse stretching, and also controlling the angle of the optical axis regularly. Even in the case where the transverse stretching may be performed through the multiple stages, it is possible to achieve the effect of suppressing the Bowing phenomenon.

When the glass transition temperature of the resin composition is Tg, the stretching may be performed in a temperature range of (Tg−20° C.) to (Tg+30° C.). This stretching temperature ranges from the temperature at which the storage modulus of the resin composition begins to be lowered allowing loss modulus to become greater than the storage modulus, to the temperature at which the orientation of polymer chains is loosened and vanished. The glass transition temperature of the resin composition may be measured by using a differential scanning calorimeter (DSC). The stretching temperature is preferably the glass transition temperature of the resin composition.

In the case of a small-sized stretching machine (e.g., universal testing machine, Zwick Z010), the stretching is preferably performed at 1 to 100 ram/min. In the case of a pilot stretching machine, the stretching rate is preferably in the range of 0.1 to 2 mm/min. In addition, a stretching ratio is preferably in the range of about 5 to about 300%.

The optical film of the present invention prepared as above has an in-plane retardation value (Rᵢₙ) of about 0 nm to about 10 nm, and preferably about 0 nm to about 5 nm, represented by the following Mathematical Equation 1 and a thickness retardation value (Rₜₕ) of about −5 nm to about 10 nm, preferably −5 nm to 5 nm, represented by the following Mathematical Equation 2.

Rᵢₙ=(nₓ−n_{y})×d [Mathematical Equation 1]

Rₜₕ=(n_{z}−n_{y})×d [Mathematical Equation 2]

where, nₓ is a refractive index in a direction in which the refractive index is maximal in an in-plane direction of the film, n_{y} is a refractive index in a direction perpendicular to the nₓ direction in the in-plane direction of the film, n_{z} is a refractive index in a thickness direction, and d is a thickness of the film.

Also, a coefficient of thermal expansion of an optical film including the resin composition according to the present invention ranges from about 40 to about 80 ppm/K, and preferably about 50 to about 65 ppm/K. When the optical film according to the present invention is used as a protective film for a polarizing plate, curling may be minimized due to the optical film having a low coefficient of thermal expansion.

In addition, the optical film according to the present invention has the thickness of 20 to 200 μm, and preferably 40 to 120 μm, transparency of about 0.1 to about 3%, and light transmittance of 90% or more. When the film thickness, transparency and transmittance fall within these ranges, the optical film is suitably used for a protective film for a polarizing plate.

In addition, the content of residual monomer is preferably 700 ppm or less. If the content of residual monomer in the film exceeds 700 ppm, defects such as a fish eye may easily occur. Also, an adhesive property of a polarizer may be deteriorated by migration of residual monomers during a process of being laminated with a polarizer requiring a relatively high temperature (80 to 90° C.), and other defects may occur such as air bubbles generated between the polarizer and the optical film.

Another aspect of the present invention relates to a polarizing plate including a polarizer, and the optical film disposed on at least one side of the polarizer as a protective film. The optical film according to the present invention may be disposed on one or both sides of the polarizer. If the optical film is disposed on one side of the polarizer, a polarizer protection film well-known in the related art, for example, a TAC film, a PET film, a COP film, a norbornene film may be provided on the other side of the polarizer. For example, a TAC film is particularly preferable in terms of economic feasibility. Since the optical film according to the present invention is similar in coefficient of thermal expansion to a TAC film, a curling phenomenon caused by a difference in the coefficient of thermal expansion therebetween may be minimized by forming the TAC film on one side of the polarizer and forming the optical film according to the present invention on the other side of the polarizer.

Meanwhile, the lamination of the polarizer and the optical film and/or protective film may be carried out by coating an adhesive on a film or polarizer using roll coater, gravure coater, bar coater, knife coater or capillary coater, and then hot-laminating a protective film and polarizer using a laminating roll, or press-laminating at room temperature. The adhesive may include adhesives well-known in the related art, and, for example, a polyvinyl alcohol adhesive, a polyurethane adhesive or an aryl adhesive may be used as the adhesive without any limitation.

Another aspect of the present invention relates to an image display device including the polarizing plate according to the present invention. The display device may be, for example, a liquid crystal display (LCD), a plasma display (PDP) an electroluminescence device (LED), or the like.

### Mode for Invention

Hereinafter, the present invention will be more fully described through specified Examples. The below-described Examples are exemplarily provided merely for understanding of the present invention, and thus the scope of the present invention is not limited thereto.

The evaluation methods of physical properties in Examples of the present invention were performed as follows.

1. Glass Transition Temperature (Tg): measured by using a Differential Scanning calorimeter (DSC) made by TA Instrument, Co.

2. Retardation values (Rᵢₙ, Rₜₕ): measured by using an AxoScan made by Axometrics, Co., after stretching a film at the glass transition temperature.

3. Coefficient of thermal expansion (ppm/° C.): measured by using a TMA which is one of thermal expansion coefficient measuring apparatuses made by TA Instruments, Co., after biaxially stretching a film.

4. Yellow index (ASTM D 1925): measured by using a colorimeter for 3-mm thick injection specimen.

5. Content of residual monomer: measured by using GC/FID (Model EQC-0248) after dissolving 5 g of sample using acetone and precipitating the sample using methanol.

### EXAMPLES 1 to 10

85 parts by weight of a methyl methacrylate monomer, 10 parts by weight of a methacrylic acid monomer and 5 parts by weight of a benzyl methacrylate monomer were mixed with toluene used as a polymerization solvent, and then a polymerization initiator, an oxidation inhibitor and a molecular weight regulator were added thereto, followed by polymerization using continuous bulk polymerization. Thereafter, the product produced by the polymerization reaction was dried using a drying reactor under the conditions of temperature, drying time and discharging amount as shown in Tables 1 and 2 to prepare a resin composition. A glass transition temperature, a content of residual monomer and a yellow index of the resin prepared were measured, and the results are summarized in Table 1 and Table 2.

Afterwards, an optical film was prepared from the resin using a T-die extruder, and thereafter retardation value, coefficient of thermal expansion and content of residual monomer of the prepared optical film were measured. The results are summarized in Table 1 and Table 2.

TABLE 1

| | | Example 1 | Example 2 | Example 3 | Example 4 | Example 5 |
|---|---|---|---|---|---|---|
| Drying | Drying | 270 | 270 | 270 | 240 | 240 |
| condition | temperature (° C.) | | | | | |
| | Drying time (hr) | 2 | 1.5 | 1 | 2 | 1 |
| | Discharging | 3.2 | 3.8 | 4.4 | 3.2 | 4.4 |
| | amount (kg/hr) | | | | | |
| Resin | Tg (° C.) | 132 | 132 | 131 | 130 | 130 |
| property | YI | 4.0 | 3.4 | 2.4 | 2.8 | 1.4 |
| | Residual | 400 | 550 | 950 | 1050 | 1350 |
| | monomer (ppm) | | | | | |
| Film | Retardation (Rᵢₙ/Rₜₕ) | 0.1/−2.1 | 0.3/−1.8 | 0.2/−1.0 | 0.2/−1.4 | 0.6/−1.0 |
| property | | | | | | |
| | Coefficient of | 60 | 60 | 60 | 60 | 61 |
| | thermal | | | | | |
| | expansion (ppm/° C.) | | | | | |
| | Residual | 200 | 230 | 330 | 430 | 520 |
| | monomer (ppm) | | | | | |

TABLE 2

| | | Example 6 | Example 7 | Example 8 | Example 9 | Example 10 |
|---|---|---|---|---|---|---|
| Drying | Drying | 240 | 250 | 260 | 270 | 260 |
| condition | temperature (° C.) | | | | | |
| | Drying time (hr) | 0.5 | 1 | 1 | 0.5 | 1.5 |
| | Discharging | 5.0 | 4.4 | 4.4 | 5 | 3.8 |
| | amount (kg/hr) | | | | | |
| Resin | Tg (° C.) | 129 | 130 | 130 | 130 | 130 |
| property | YI | 0.8 | 1.7 | 2.0 | 1.5 | 3.1 |
| | Residual | 1950 | 1250 | 1050 | 1450 | 810 |
| | monomer (ppm) | | | | | |
| Film | Retardation (Rᵢₙ/Rₜₕ) | 0.2/2.0 | 0.5/1.0 | 0.3/−1.1 | 0.2/−1.0 | 0.6/−1.0 |
| property | Coefficient of | 64 | 62 | 60 | 62 | 61 |
| | thermal | | | | | |
| | expansion (ppm/° C.) | | | | | |
| | Residual | 630 | 500 | 460 | 600 | 520 |
| | monomer (ppm) | | | | | |

### COMPARATIVE EXAMPLES 1 to 6

85 parts by weight of a methyl methacrylate monomer, 10 parts by weight of a methacrylic acid monomer and 5 parts by weight of a benzyl methacrylate monomer were mixed with toluene used as a polymerization solvent, and a polymerization initiator, an oxidation inhibitor and a molecular weight regulator were then added thereto, followed by polymerization using continuous bulk polymerization. Thereafter, the product produced by the polymerization reaction was dried using a drying reactor under the conditions of temperature, drying time and discharging amount condition as shown in Table 3. Glass transition temperature and yellow index of the prepared resin were measured, and the results are summarized in Table 3.

Afterwards, an optical film was prepared from the resin using a T-die extruder, and thereafter a retardation value, a coefficient of thermal expansion, and a content of residual monomer in the prepared optical film were measured. The results are summarized in Table 3.

TABLE 3

| | | Compara- | Compara- | Compara- | Compara- | Compara- | Compara- |
|---|---|---|---|---|---|---|---|
| | | tive | tive | tive | tive | tive | tive |
| | | Example 1 | Example 2 | Example 3 | Example 4 | Example 5 | Example 6 |
| Drying | Drying | 270 | 240 | 250 | 270 | 280 | 230 |
| condition | temperature (° C.) | | | | | | |
| | Drying time (hr) | 2.5 | 0.3 | 3.0 | 3.0 | 2.0 | 0.3 |
| | Discharging | 2.3 | 5.3 | 5.3 | 1.6 | 3.2 | 5.3 |
| | amount (kg/hr) | | | | | | |
| Resin | Tg (° C.) | 130 | 117 | 126 | 118 | 114 | 111 |
| property | YI | 6.4 | 0.4 | 4.6 | 8.0 | 8.5 | 1.2 |
| | Residual | 2850 | 3750 | 3450 | 4300 | 8310 | 7250 |
| | monomer (ppm) | | | | | | |
| Film | Retardation (Rᵢₙ/Rₜₕ) | 2.2/−3.0 | 2.8/4.0 | 1.4/−3.4 | 0.2/−6.0 | 0.6/−8.4 | 0.4/1.4 |
| property | | | | | | | |
| | Coefficient of | 69 | 85 | 64 | 65 | 93 | 88 |
| | thermal | | | | | | |
| | expansion (ppm/° C.) | | | | | | |
| | Residual | 1380 | 1980 | 1960 | 2010 | 3130 | 3940 |
| | monomer (ppm) | | | | | | |

As shown in the Tables 1 to 3, it can be understood that one property of heat resistance, yellow index and coefficient of thermal expansion is deteriorated when the content of residual monomer in the resin composition exceeds 2000 ppm. In addition, it can be understood that the content of residual monomer is increased when a drying temperature is below 240° C. or a residence time is short, whereas glass transition temperature, coefficient of thermal expansion and yellow index are deteriorated when the drying temperature is above 270° C. or the residence time is extended.

1. A resin composition for an optical film comprising a copolymer,
the copolymer including:
an alkyl (meth)acrylate unit;
a (meth)acrylate unit having a benzene ring; and
a (meth)acrylic acid unit,
wherein a content of a residual monomer in the resin composition is 2000 ppm or less.

2. The resin composition of claim 1, wherein the copolymer further includes a unit represented by following Chemical Formula 1, 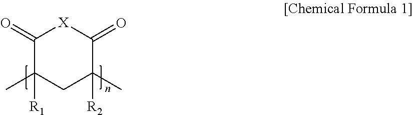
where X is nitrogen (N) or oxygen (O),and
R₁ and R₂ are hydrogen (H), a C₁ to C₁₀ alkyl group, a C₃ to C₂₀ cycloalkyl group or a C₃ to C₂₀ aryl group, respectively.

3. The resin composition of claim 1, wherein a content ratio among the alkyl (meth)acrylate unit, the (meth)acrylate unit having the benzene ring, and the (meth)acrylic acid in the copolymer is 70 to 95:2 to 10:3 to 20 by weight ratio.

4. The resin composition of claim 2, wherein a content ratio among the alky (meth)acrylate unit, the (meth)acrylate unit having the benzene ring, the (meth)acrylic acid, and the unit represented by Chemical Formula 1 in the copolymer is 60 to 90:2 to 10:3 to 10:5 to 20 by weight ratio.

5. The resin composition of claim 1, wherein an alkyl group of the alkyl (meth)acrylate has 1 to 10 carbon atoms.

6. The resin composition of claim 5, wherein the alkyl (meth)acrylate unit is methyl methacrylate.

7. The resin composition of claim 1, wherein the alkyl (meth)acrylate unit is one or more species selected from the group consisting of benzyl methacrylate, benzyl acrylate, 1-phenylethyl methacrylate, 2-phenoxyethyl methacrylate, 2-phenylethyl methacrylate, 3-phenylpropyl methacrylate, 3-phenylpropyl acrylate, and 2-phenoxyethyl acrylate.

8. The resin composition of claim 1, wherein the (meth)acrylic acid is selected from the group consisting of acrylic acid, methacrylic acid, methylacrylic acid, methylmethacrylic acid, ethylacrylic acid, ethylmethacrylic acid, butylacrylic acid and butyl methacrylic acid.

9. The resin composition of claim 2, wherein the compound represented by Chemical Formula 1 is glutaric anhydride.

10. The resin composition for an optical film of claim 1, wherein the glass transition resin for an optical film is in the range of 120° C. to 500° C.

11. The resin composition of claim 1, wherein weight average molecular weight of the resin for an optical film is 100,000 to 500,000.

12. The resin composition of claim 1, wherein a yellow index of a 3-mm thick injection specimen is 4 or lower.

13. An optical film comprising the resin composition as set forth in claim 1.

14. The optical film of claim 13, wherein the optical film has, at a wavelength of 580 nm, an in-plane retardation value of 0 nm to 5 nm, represented by the following Mathematical Equation 1, and a thickness retardation value of −5 nm to 5 nm, represented by the following Mathematical Equation 2,
Rᵢₙ=(nₓ−n_{y})×d [Mathematical Equation 1]
Rₜₕ=(n_{z}−n_{y})×d [Mathematical Equation 2]
where,
nₓ is a refractive index in a direction in which the refractive index is maximal in an in-plane direction of the film,
n_{y} is a refractive index in a direction perpendicular to the n_{X} direction in the in-plane direction of the film,
n_{z} is a refractive index in a thickness direction, and
d is a thickness of the film.

15. The optical film of claim 13, wherein a linear coefficient of thermal expansion is 40 to 80 ppm/° C.

16. The optical film of claim 13, wherein a content of residual monomer in the optical film is 700 ppm or less.

17. The optical film of claim 13, wherein the optical film has, at a wavelength of 580 nm, an in-plane retardation value of 0 nm to 5 nm, represented by the following Mathematical Equation 1 and a thickness retardation value of −5 nm to 5 nm, represented by the following Mathematical Equation 2, and has a coefficient of thermal expansion of 50 to 65 ppm/° C., and a content of residual monomer of 700 ppm or less,
Rᵢₙ=(nₓ−n_{y})×d [Mathematical Equation 1]
Rₜₕ=(n_{z}−n_{y})×d [Mathematical Equation 2]
where,
nₓ is a refractive index in a direction in which the refractive index is maximal in an in-plane direction of the film,
n_{y} is a refractive index in a direction perpendicular to the nₓ direction in the in-plane direction of the film,
n_{z} is a refractive index in a thickness direction, and
d is a thickness of the film.

18. A polarizing plate comprising:
a polarizer; and
the optical film of claim 13 disposed on at least one side of the polarizer as a protective film.

19. A method for preparing an optical film, comprising:
(1) copolymerizing an alkyl (meth)acrylate monomer, a (meth)acrylate monomer having a benzene ring, and a (meth)acrylic acid monomer; and
(2) drying the resulting copolymerized product in a temperature range of 240° C. to 270° C. for 30 minutes to 2 hours.

20. The method of claim 19, wherein the discharging amount in the drying operation is in the range of 3 kg/hr to 6 kg/hr based on 20-L pilot reactor.
